(19) United States
(12) Patent Application Publication
(10) Pub. No.: US 2006/0039040 A1
(43) Pub. Date: Feb. 23, 2006

(54) Image forming device and image forming method

(75) Inventor: Masanori Asakura, Otsu-shi (JP)

Correspondence Address: HOGAN & HARTSON L.L.P., 500 S. GRAND AVENUE, SUITE 1900, LOS ANGELES, CA, 90071-2611, US

(73) Assignee: MURATA KIKAI KABUSHIKI KAISHA

(21) Appl. No.: 11/190,086

(22) Filed: Jul. 25, 2005

(30) Foreign Application Priority Data
Aug. 17, 2004 (JP) 2004-236942

(51) Int. Cl. H04N 1/40

(52) U.S. Cl. 358/471

(57) ABSTRACT

The present invention relates to an image forming device and an image forming method using an LED print head. A number of black pixels is counted for a prescribed unit within input image data, and a number of black isolated points is counted for the prescribed unit within the input image data. In accordance with the counted number of the black pixels and the counted number of the black isolated points, strobe signals having different time widths are generated for a corresponding unit of the LED print head.

### BACKGROUND OF THE INVENTION

1. Field of the Invention

The present invention relates to an image forming device, such as a copying machine, a facsimile machine, a multifunction peripheral having multiple functions, such as a copying function and a facsimile function, and a printer device, and an image forming method.

2. Description of Related Art

A known printer (image forming device) uses a Light Emitting Diode (LED) print head. The LED print head includes a plurality of LED elements arranged on one line. In the LED print head, when voltage is applied simultaneously to all of the LED elements (pixels) and light is emitted simultaneously from the LED elements, a large electric current is required to be transmitted. Therefore, the entire LED print head is divided into two blocks or divided into four or eight blocks, and the light is emitted from each of the blocks by time sharing. However, even under such a driving method, a value of an electric current passing through each of the LEDs differs in each of the blocks according to a number of the LEDs to be lighted.

That is, when a number of the LEDs to be lighted is large, the electric current passing through each of the LEDs is small and luminance of the LED is low. When the number of the LEDs to be lighted is small, the electric current passing through each of the LEDs is large and luminance of the LED is high. Therefore, depending on a number of black pixels, a size of black dots printed on printing paper differs, and there exists a drawback of deterioration in an image quality. In consideration of such a drawback, conventionally, a proposal is made for a technology for shortening a period of time of a strobe (STR) signal applied to the LED print head when the number of the black pixels is small, and a technology for shortening a period of time of the strobe (STR) signal in case of a digital halftoning.

According to the above-described conventional technology, unevenness in the size of the black dots printed on the printing paper can be suppressed to some extent depending on the number of the black dots. Meanwhile, since a black dot does not exist around a black dot of an isolated point, compared with a case in which the dots are continuous, the size of the black dots formed is prone to be small even with the same energy. Since the electric current passing through the LED increases if a block includes a small number of black pixels (regardless of whether a black pixel is an isolated point or not), the above-mentioned drawback is not remarkable. However, there exists a drawback that if one line includes black pixels to some extent or more and a certain number of isolated points are included in the black pixels, a black dot of an isolated point is formed small.

### SUMMARY OF THE INVENTION

The present invention has been made in consideration of the above-described drawbacks. An advantage of the present invention is to provide an image forming device and an image forming method which can form an image without a black dot being formed small even when isolated points are included to some extent or more.

According to a first aspect of the present invention, a device records an electrostatic latent image on a photoconductive body by using an LED print head. The device counts a number of black pixels (a first counted number) for a prescribed unit of data, and counts a number of isolated points (a second counted number) for the prescribed unit of the data. When the first counted number is a first prescribed number or larger and the second counted number is a second prescribed number or larger, a light-emitting time of an LED is lengthened for the prescribed unit.

Suppose that the first counted number (the number of the black pixels) for the prescribed unit of the data is the first prescribed number or larger and the second counted number (the number of the isolated points) for the prescribed unit of the data is the second prescribed number or larger. Under such a state, the black pixels are included to some extent or more in a prescribed range of the data, and the black pixels include the isolated points for a certain number or more. Therefore, the light-emitting time of the LED is lengthened. By lengthening the light-emitting time, a size of a black dot of an isolated point can be prevented from becoming small.

The prescribed unit is preferably a block of a number of pixels formed by diving pixels of one line by a natural number. Although the natural number depends on the number of pixels of one line, normally, the natural number is 2ⁿ (n=1, 2, 3, . . . ), for example, 2, 4 or 8.

According to a second aspect of the present invention, a control of a driving of the LED preferably generates a plurality of strobe signals having different time periods, selects one of the plurality of the strobe signals and outputs the selected strobe signal for the prescribed unit.

When the first counted number (the number of the black pixels) is the first prescribed number or larger and the second counted number (the number of the isolated points) is the second prescribed number or larger, the strobe signal is output to the block for a longer period of time. As a result, a black dot of an isolated point can be formed clearly and an image quality can be improved. Two or more strobe signal generating circuits can be provided for generating strobe signals having different time periods for emitting light from the LED. A strobe signal can be applied to the LED print head by switching the strobe signal generating circuits. As a result, an electric circuit can be simplified.

### BRIEF DESCRIPTION OF THE SEVERAL VIEWS OF THE DRAWINGS

FIG. 1 is a block diagram showing a schematic configuration of the entire image forming device according to an embodiment of the present invention.

FIG. 2 is a block diagram showing a configuration of a strobe signal generating circuit of an image forming device.

FIG. 3 is a block diagram showing a configuration of a black pixel and isolated point detecting circuit of an image forming device.

FIG. 4 is a time chart showing a signal waveform of each component of an image forming device when forming an image.

### DETAILED DESCRIPTION OF THE INVENTION

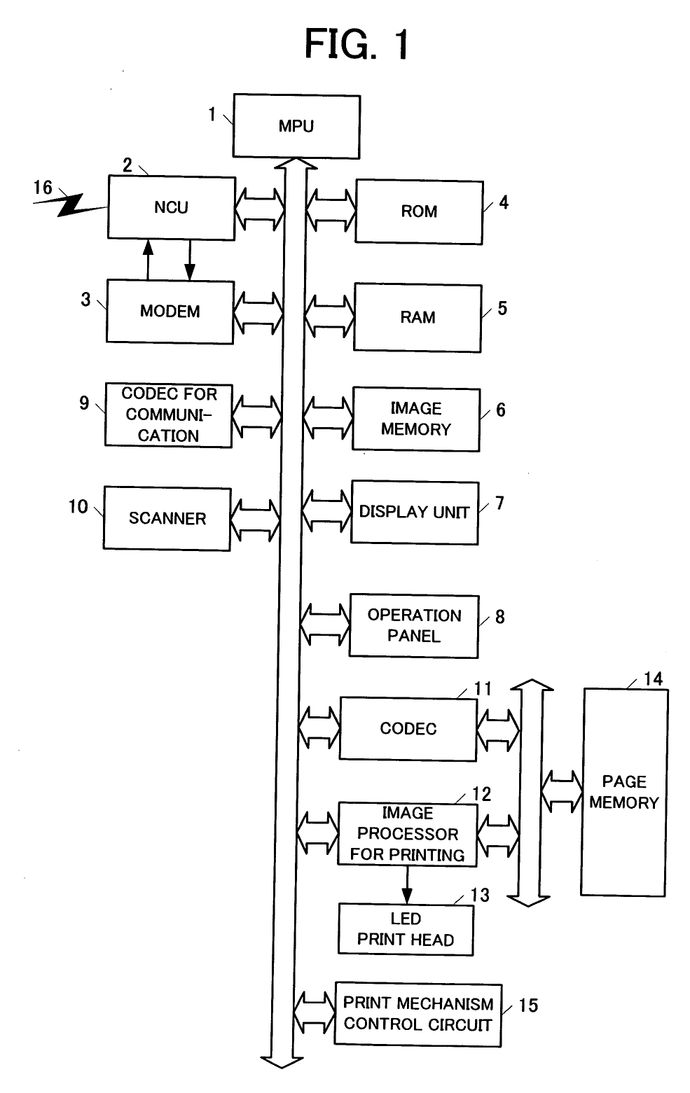

An embodiment of the present invention will be described. FIG. 1 is a block diagram showing the entire configuration of an image forming device according to an embodiment of the present invention. The image forming device is a multifunction peripheral having a facsimile function and a copying function. The image forming device includes a Micro Processor Unit (MPU) 1, a Network Control Unit (NCU) 2, a modulator-demodulator (MODEM) 3, a Read Only Memory (ROM) 4, a Random Access Memory (RAM) 5, an image memory 6, a display unit 7, an operation panel 8, a coder-decoder (CODEC) 9 for communication, a scanner 10, a CODEC 11, an image processor for printing 12, a LED print head 13, a page memory 14 and a print mechanism control circuit 15.

The MPU 1 has a function for controlling each component of the image forming device in accordance with a program stored in the ROM 4. The MPU 1 has a clocking function which can clock an elapse of a predetermined period of time. The NCU 2 controls a connection with a Public Switched Telephone Network (PSTN) 16. The NCU 2 has a function for transmitting an address signal corresponding to a telephone number of a destination, and a function for detecting a ring signal. The MODEM 3 modulates transmission data and demodulates received data by following V.17, V.27ter, V.29, etc. in accordance with a facsimile transmission control protocol of the International Telecommunication Union-Telecommunications (ITU-T) Recommendation T. 30. Alternatively, the MODEM 3 modulates transmission data and demodulates received data by following V.34 in addition to V.17, V.27ter, V.29, etc.

The ROM 4 stores a program for controlling the image forming device. The RAM 5 temporarily stores data or the like processed by the MPU 1. The image memory 6 stores received image data or image data scanned by the scanner. The display unit 7 displays, for example, information to be conveyed from the image forming device to an operator. The operation panel 8 includes operation key switches such as a ten-key numeric pad, a FAX key, a copy key, a start key and a speed dial key. The CODEC 9 for communication encodes transmission image data by a Modified Huffman (MH), a Modified READ (MR) or a Modified MR (MMR) scheme or the like and decodes received image data. The scanner 10 scans and reads an original document when copying the original document or when transmitting the original document by facsimile.

The CODEC 11 is used for decoding the image data for printing. The image processor for printing 12 fetches printing image data stored in the page memory 14, executes an image processing and supplies image data, a clock signal, a strobe signal or the like to the LED print head 13.

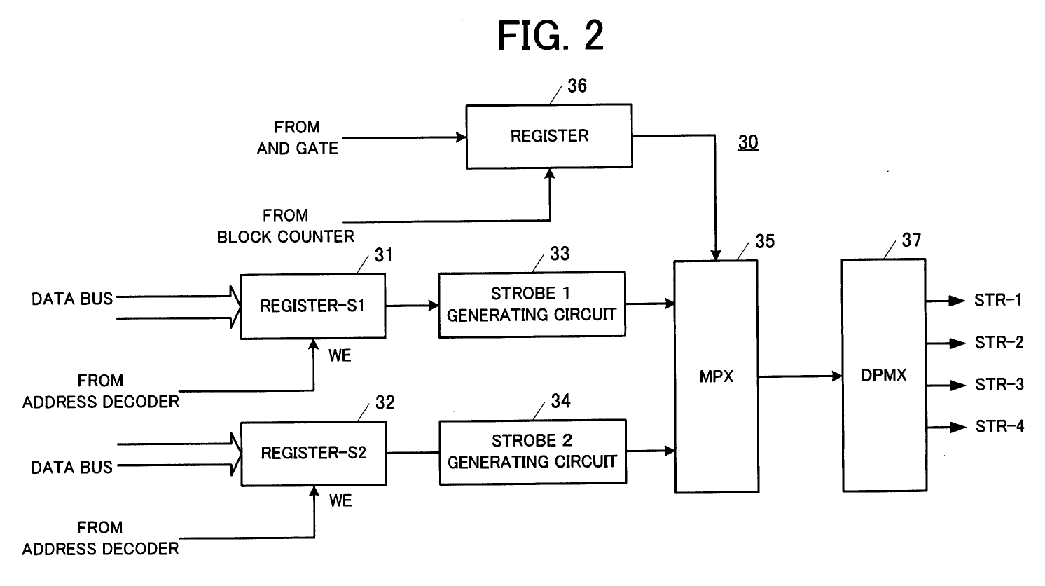

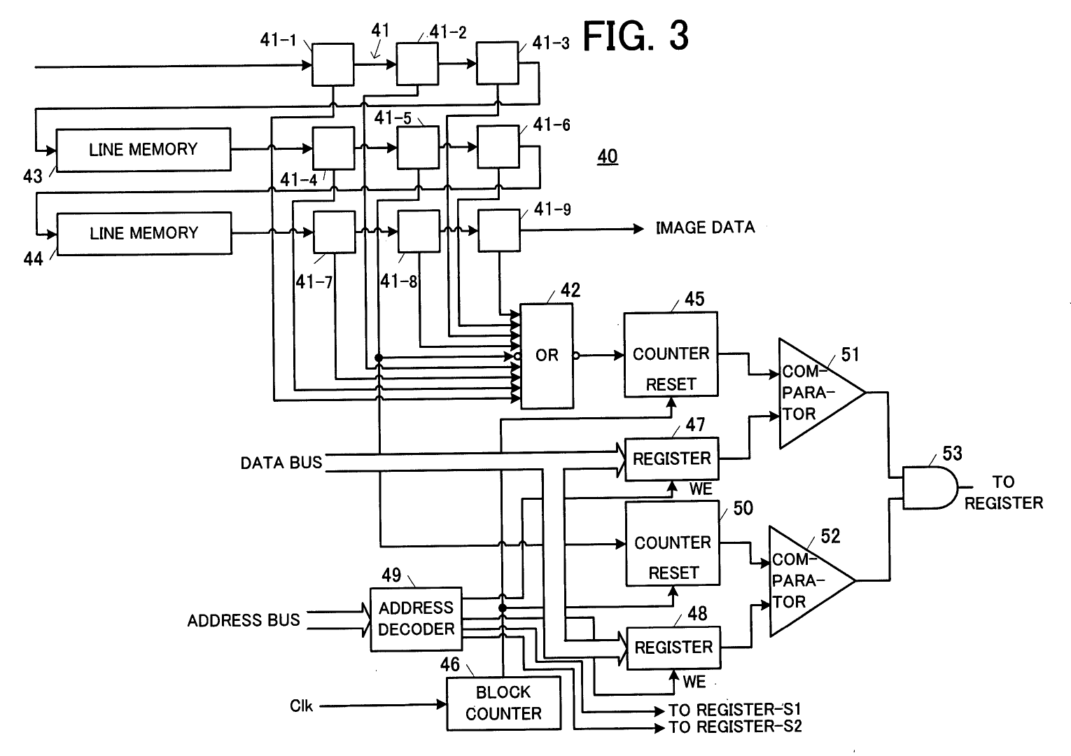

The image processor for printing 12 includes a comparator (a circuit 40 of FIG. 3) and a strobe signal generating circuit (a circuit 30 of FIG. 2). The comparator 40 detects a number of isolated points of black pixels and a number of black pixels for each image area corresponding to a strobe signal, and determines whether or not the number of the isolated points and the number of the black pixels have respectively exceeded a threshold value. In accordance with the determination of whether or not the number of the isolated points and the number of the black pixels have respectively exceeded the threshold value, the strobe signal generating circuit 30 controls duration when the strobe signal is switched ON.

The strobe signal generating circuit 30 generates four strobe signals STR-1, STR-2, STR-3 and STR-4 to each of four blocks divided from a driving period of one line. In addition, the strobe signal generating circuit 30 can select and output a time length (ON width) of the strobe signals STR-1, STR-2, STR-3 and STR-4 for a time length longer than a normal time length in each of the blocks.

FIG. 2 is a block diagram showing a configuration of the strobe signal generating circuit 30. The strobe signal generating circuit 30 includes a register-S1 31, a register-S2 32, a strobe 1 generating circuit 33, a strobe 2 generating circuit 34, a multiplexer (MPX) circuit 35, a register 36 and a demultiplexer (DMPX) circuit 37.

The register-S1 31 receives an input of data indicating a normal time length (ON width) of the strobe signal from a data bus, receives a Write Enable (WE) from an address decoder 49 (refer to FIG. 3) and stores the data. The strobe 1 generating circuit 33 outputs a strobe signal at the normal ON width stored in the register-S1 31. The register-S2 32 receives an input of data indicating a time length (ON width) longer than the normal time length of the strobe signal from a data bus, receives a Write Enable (WE) from the address decoder 49 and stores the data. The strobe 2 generating circuit 34 outputs a strobe signal at the ON width longer than the normal ON width stored in the register-S2 32.

While a signal of a logical value “1” is input from an AND gate circuit 53 to be described later shown in FIG. 3, when a block counter 46 counts up and a logical value “1” is input, the register 36 stores “1”. The register 36 adds the stored logical value “1” to the MPX circuit 35. When the MPX circuit 35 receives a signal of a logical value “0” from the register 36, the MPX circuit 35 selects and outputs a strobe signal of the normal ON width from the strobe 1 generating circuit 33. Meanwhile, when the MPX circuit 35 receives a signal of a logical value “1” from the register 36, the MPX circuit 35 outputs a strobe signal having an ON width longer than the normal ON width from the strobe 2 generating circuit 34.

The DMPX circuit 37 sequentially outputs the strobe signals STR-1, STR-2, STR-3 and STR-4 of first, second, third and fourth blocks input from the MPX circuit 35. The strobe signals STR-1, STR-2, STR-3 and STR-4 are input to the LED print head 13.

The black pixel and isolated point detecting circuit 40 counts a number of black pixels for each of four blocks divided from one line and also counts a number of isolated points. When the number of the black pixels and the number of the isolated points respectively exceed a prescribed number, the black pixel and isolated point detecting circuit 40 outputs a signal indicating such a fact.

FIG. 3 is a block diagram showing a configuration of the black pixel and isolated point detecting circuit 40. The black pixel and isolated point detecting circuit 40 includes a matrix circuit 41 for detecting an isolated point, an identity gate circuit 42, line memories 43 and 44, a counter 45 for counting a number of isolated points, a block counter 46, registers 47 and 48, a counter 50 for counting a number of black pixels, comparators 51 and 52 and the AND gate circuit 53.

When pixels of 3 by 3 of image data are stored in each of storage cells 41₋₁, 41₋₂, . . . and 41₋₉ of the matrix circuit 41, a determination is made as to whether or not a pixel stored in the storage cell 41₋₅ is a black isolated point. When a stored content of the storage cell 41₋₅ is black (logical value “1”) and stored contents of other storage cells 41₋₁ through 41₋₄ and 41₋₆through 41₋₉ are white (logical value “0”), the pixel stored in the storage cell 41₋₅ is a black isolated point. A logical value “1” is output from the identity gate circuit 42 and the counter 45 counts a black isolated point 1.

The block counter 46 counts each block divided from one line each time when the block switches from the first block, the second block, the third block and to the fourth block. A count is counted up to four counts, and a next count starts from one. Each time when the count is counted up, the counters 45 and 50 are reset. Therefore, the counter 45 detects and counts the black isolated point for each block.

The output from the storage cell 41₋₅ of the matrix circuit 41 is also input to the counter 50. The counter 50 counts one each time when the pixel stored in the storage cell 41₋₅ is “black”. The counter 50 is also reset for each block. Therefore, the counter 50 counts the number of the black pixels for each block.

Threshold value data of the number of the black isolated points is input from the data bus to the register 47, and the register 47 stores the threshold value data upon receiving a write enable signal WE from the address decoder 49. Threshold value data of the number of the black pixels is also input from the data bus to the register 48, and the register 48 also stores the threshold value data upon receiving a write enable signal WE from the address decoder 49.

The comparator 51 compares the number of the isolated points of the counter 45 and the threshold value of the register 47 for each block. The comparator 52 compares the number of the black pixels of the counter 50 and the threshold value of the register 48. When the number of the isolated points is larger than the threshold value, the comparator 51 outputs HIGH (logical value “1”). When the number of the black pixels is larger than the threshold value, the comparator 52 outputs HIGH (logical value “1”). When both the number of the isolated points and the number of the black pixels exceed the respective threshold values, both of the inputs at the AND gate circuit 53 are the logical value “1”, and the logical value “1” is output from the AND gate circuit 53.

On the contrary, when LOW (logical value “0”) is output from either one of the comparators 51 and 52, that is, when either the number of the isolated points or the number of the black pixels is smaller than the respective threshold values, both of the inputs at the AND gate circuit 53 do not match with the logical value “1”, and the logical value “0” is output from the AND gate circuit 53.

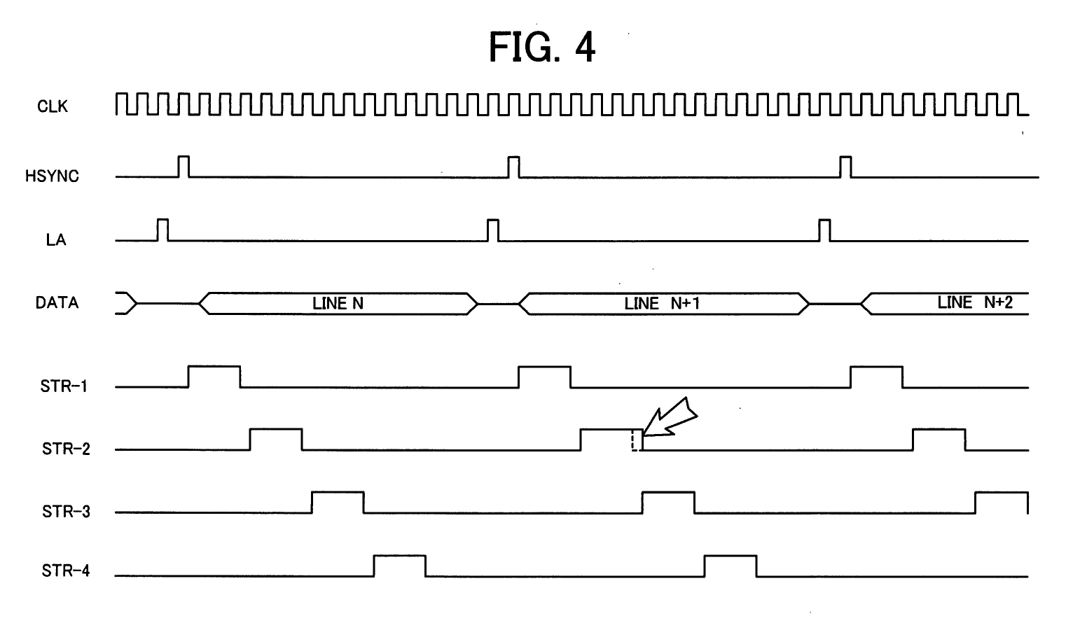

In the present embodiment, suppose that in a line N of printing data, the number of the isolated points and the number of the black pixels in all of the first block, the second block, the third block and the fourth block are smaller than the respective threshold values, and thus a signal of the logical value “1” is not added from the AND gate circuit 53 to the MPX circuit 35. Then, for each block, the strobe 1 generating circuit 33 selects and outputs a strobe signal of a normal ON width. As shown in FIG. 4, the strobe signals STR-1, STR-2, STR-3 and STR-4 output from the DMPX circuit 37 respectively have a short ON width (normal time period). Each LED of the LED print head 13, which received the strobe signals STR-1, STR-2, STR-3 and STR-4, emits light for the normal time period.

Next, in a subsequent line N+1, for example, when both the number of the isolated points and the number of the black pixels in a second block exceed the respective threshold values, a signal of the logical value “1” is added from the AND gate circuit 53 to the MPX circuit 35 for the second block. Accordingly, only for the timing of the second block, the MPX circuit 35 selects and outputs a strobe signal having a time length (ON width) longer than the normal time length from the strobe 2 generating circuit 34. Therefore, among the strobe signals STR-1, STR-2, STR-3 and STR-4 output from the DMPX circuit 37, as shown with an arrow for the line N+1 of FIG. 4, only the strobe signal STR-2 has a long ON width (time period longer than the normal time period). Since both the number of the isolated points and the number of the black pixels are larger than a prescribed number, the electric current passing through the LED of a target pixel is small. Consequently, an energization time period is long and each LED emits light for a long period of time. As a result, a black dot can be prevented from becoming small in the printing process.

Further, in the present embodiment, a period of one line is divided into four periods and the driving is carried out. However, the present invention is not limited to such an example. The period of one line may be divided into two or eight or may be divided by other numbers. A division method may be adopted to divide a pixel of an even number order and a pixel of an odd number order. The time length of the strobe signal is set in two stages, i.e. a normal time period and a long time period. However, according to a degree of the number of the black pixels, the isolated point may select the strobe signals of a plurality of time lengths.

While the description above refers to particular embodiments of the present invention, it will be understood that many modifications may be made without departing from the scope thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

1. An image forming device, comprising:
a Light Emitting Diode (LED) print head which forms an electrostatic latent image on a photoconductive body;
a first counter which counts a number of black pixels for a prescribed unit of image data input to the LED print head;
a second counter which counts a pixel of a black isolated point for the prescribed unit of the image data input to the LED print head;
a strobe signal generating circuit which generates a strobe signal for a prescribed unit of a prescribed pixel of the LED print head; and
a determining circuit which generates a strobe signal of a time period longer than a normal time period for a corresponding unit in accordance with a count result of the first counter and a count result of the second counter.

2. The image forming device according to claim 1, further comprising:
a first register which stores a first prescribed number;
a first comparator which compares the first prescribed number stored in the first register with a count value of the first counter;
a second register which stores a second prescribed number; and
a second comparator which compares the second prescribed number stored in the second register with a count value of the second counter.

3. The image forming device according to claim 2, further comprising:
a matrix circuit which extracts image data for surrounding pixels of a target pixel; and
a black isolated point determining circuit which determines that the target pixel is a black isolated point when the target pixel is black and the surrounding pixels are all white in the matrix circuit.

4. The image forming device according to claim 2, further comprising an AND circuit to which an output from the first comparator and an output from the second comparator are input.

5. The image forming device according to claim 1, further comprising:
a plurality of strobe signal generating circuits which generate strobe signals having different time widths; and
a first selection circuit which selects one of the plurality of the strobe signals in accordance with a determination result of the determining circuit.

6. The image forming device according to claim 5, further comprising a second selection circuit which transmits the selected strobe signal to a corresponding unit of a pixel of the LED print head.

7. The image forming device according to claim 5, further comprising a third register which is connected to each of the strobe signal generating circuits and sets a time width of the strobe signals.

8. An image forming device, comprising:
means for forming an electrostatic latent image on a photoconductive body by using a Light Emitting Diode (LED) print head;
means for counting a number of black pixels for a prescribed unit of image data input to the LED print head;
means for counting a pixel of a black isolated point for the prescribed unit of the image data input to the LED print head; and
means for generating strobe signals having different time widths in accordance with a number of black pixels and a number of black isolated points for a prescribed unit of a prescribed pixel of the LED print head.

9. The image forming device according to claim 8, further comprising:
means for comparing the counted number of the black pixels with a first prescribed value; and
means for comparing the counted number of black isolated points with a second prescribed value.

10. The image forming device according to claim 9, further comprising means for generating a strobe signal of a time width longer than a normal time width when the number of the black pixels is the first prescribed value or larger and the number of the black isolated points is the second prescribed value or larger.

11. The image forming device according to claim 9, further comprising:
means for setting the first prescribed value; and
means for setting the second prescribed value.

12. The image forming device according to claim 8, further comprising means for determining that a target pixel is a black isolated point when the target pixel is black and all surrounding pixels are white.

13. The image forming device according to claim 8, further comprising:
means for generating strobe signals having different time widths; and
means for selecting the strobe signals having different time widths in accordance with the number of the black pixels and the number of the black isolated points.

14. The image forming device according to claim 13, further comprising means for setting a time width of each of the strobe signals.

15. An image forming method, comprising the steps of:
counting a number of black pixels for a prescribed unit within input image data;
counting a number of black isolated points for the prescribed unit within the input image data; and
generating strobe signals having different time widths for a corresponding unit of a Light Emitting Diode (LED) print head in accordance with the counted number of the black pixels and the counted number of the black isolated points.

16. The image forming method according to claim 15, further comprising the steps of:
determining whether the counted number of the black pixels is a first prescribed value or larger; and
determining whether the counted number of the black isolated points is a second prescribed value or larger.

17. The image forming method according to claim 16, further comprising the step of extracting as a black isolated point when a target pixel is black and surrounding pixels of the target pixel are white.

18. The image forming method according to claim 16, further comprising the step of generating a strobe signal of time width longer than a normal time width when the counted number of the black pixels is the first prescribed value or larger and the counted number of the black isolated points is a prescribed value or larger.

19. The image forming method according to claim 15, further comprising the steps of:
generating a strobe signal of a normal time width;
generating a strobe signal of a time width longer than the normal time width; and
selecting either one of the strobe signals in accordance with the counted number of the black pixels and the counted number of the black isolated points.

20. The image forming method according to claim 19, further comprising the step of selecting the strobe signal of the time width longer than the normal time width when the counted number of black pixels is the first prescribed value or larger and the counted number of the black isolated points is the prescribed value or larger.
